(19) United States
(12) Patent Application Publication
(10) Pub. No.: US 2011/0176927 A1
(43) Pub. Date: Jul. 21, 2011

(54) COMPOSITE FAN BLADE

(75) Inventors: Phillip Alexander, Colchester, CT (US); Rajiv A. Naik, Glastonbury, CT (US)

(73) Assignee: UNITED TECHNOLOGIES CORPORATION, Hartford, CT (US)

(21) Appl. No.: 12/690,308

(22) Filed: Jan. 20, 2010

(51) Int. Cl. F01D 5/14; B23P 15/04

(52) U.S. Cl. 416/230; 29/889.71

(57) ABSTRACT

A composite fan blade includes a first filament reinforced airfoil ply section, a second filament reinforced airfoil ply section and a three dimensionally woven core. The woven core is located between the first and second reinforced airfoil ply sections. The woven core includes first yarns extending in a chordwise direction and second yarns extending in a spanwise direction. There are a greater number of second yarns in a first region of the woven core than in a second region of the woven core.

### BACKGROUND

Composite materials offer potential design improvements in gas turbine engines. For example, in recent years composite materials have been replacing metals in gas turbine engine fan blades because of their high strength and low weight. Most metal gas turbine engine fan blades are titanium. The ductility of titanium fan blades enables the fan to ingest a bird and remain operable or be safely shut down.

The same requirements are present for composite fan blades. Composite fan blades must withstand interlaminar stresses, torsional stresses and in-plane stresses and strains from typical operation and from impacts by foreign objects.

### SUMMARY

A composite fan blade includes a first filament reinforced airfoil ply section, a second filament reinforced airfoil ply section and a three dimensionally woven core. The woven core is located between the first and second reinforced airfoil ply sections. The woven core includes first yarns extending in a chordwise direction and second yarns extending in a spanwise direction. There are a greater number of second yarns in a first region of the woven core than in a second region of the woven core.

### BRIEF DESCRIPTION OF THE DRAWINGS

FIG. 1 is a cross-sectional view of a gas turbine engine having a fan.

FIG. 2 is a side view of a composite fan blade.

FIGS. 3a, 3b and 3c are cross-sectional views of the composite fan blade of FIG. 2 taken along line 3a-3a, line 3b-3b and line 3c-3c, respectively.

FIG. 4 is an enlarged cross-sectional view of a root of the composite fan blade illustrating dropping surface warp yarns.

FIG. 5 is an enlarged cross-sectional view of the root of the composite fan blade illustrating dropping below surface warp yarns.

### DETAILED DESCRIPTION

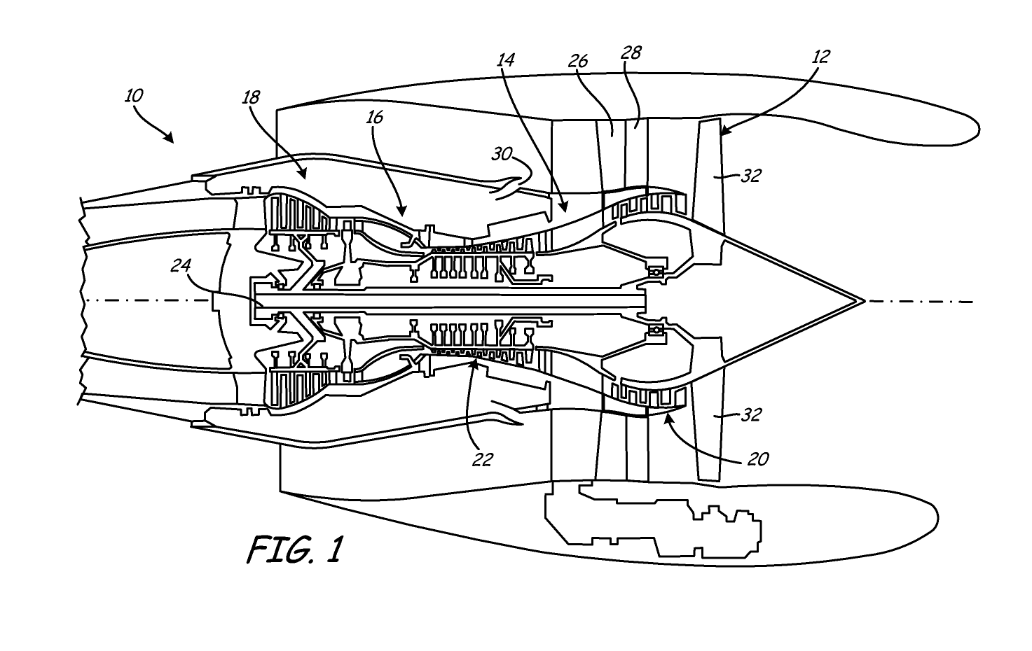

FIG. 1 is a cross-sectional view of gas turbine engine 10, which includes turbofan 12, compressor section 14, combustion section 16 and turbine section 18. Compressor section 14 includes low-pressure compressor 20 and high-pressure compressor 22. Air is taken in through fan 12 as fan 12 spins. A portion of the inlet air is directed to compressor section 14 where it is compressed by a series of rotating blades and vanes. The compressed air is mixed with fuel, and then ignited in combustor section 16. The combustion exhaust is directed to turbine section 18. Blades and vanes in turbine section 18 extract kinetic energy from the exhaust to turn shaft 24 and provide power output for engine 10.

The portion of inlet air which is taken in through fan 12 and not directed through compressor section 14 is bypass air. Bypass air is directed through bypass duct 26 by guide vanes 28. Then the bypass air flows through opening 30 to cool combustor section 16, high pressure compressor 22 and turbine section 18.

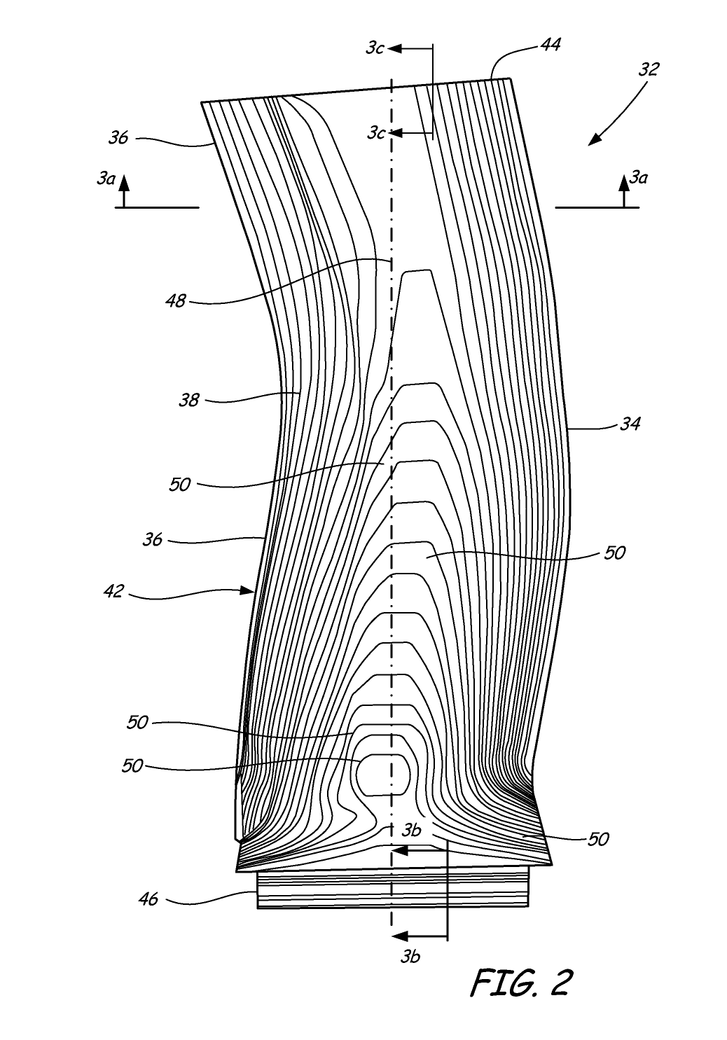

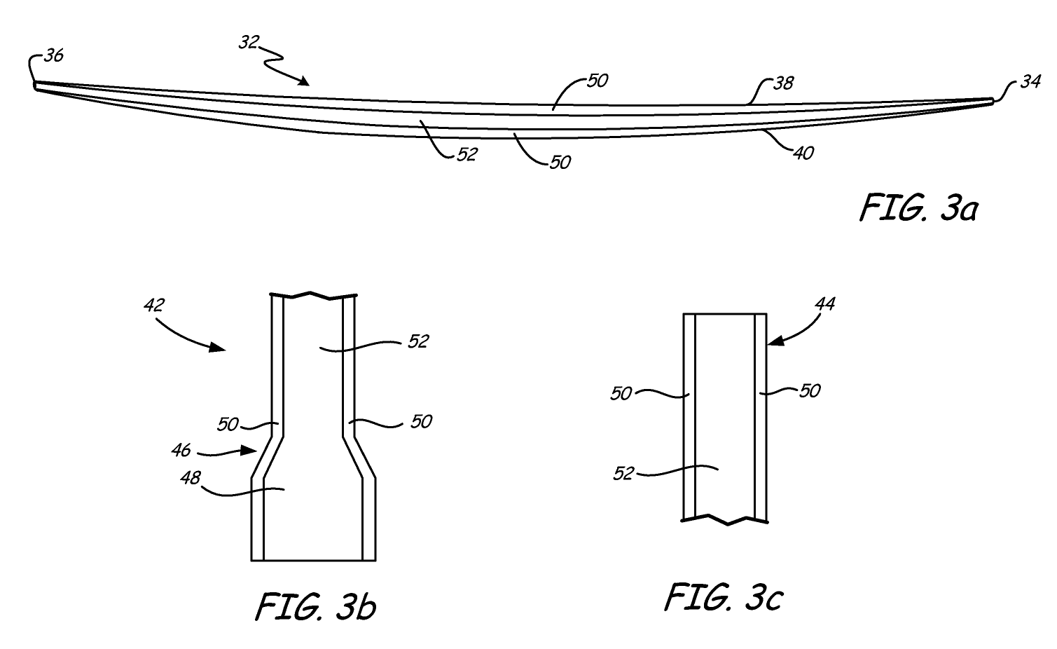

Fan 12 includes a plurality of composite blades 32. FIG. 2 illustrates one composite blade 32, which includes leading edge 34, trailing edge 36, pressure side 38, suction side 40 (shown in FIG. 3a), airfoil 42 (having tip 44), root 46, longitudinal axis 48 and plies 50. Root 46 is illustrated as a dovetail root. However, root 46 can have any configuration. Longitudinal axis 48 extends in the spanwise direction from root 46 to tip 44.

Plies 50 are two-dimensional fabric skins. Elongated fibers extend through plies 50 at specified orientations and give plies 50 strength. Plies 50 can vary in size, shape and fiber orientation. Plies 50 can comprise a woven fabric or a uniweave material. In a woven fabric, half of the fibers are orientated in a first direction and the other half of the fibers are oriented 90° to the first direction. For example, half of the fibers of a 0/90° woven fabric are oriented along the longitudinal axis and the other half of the fibers are oriented along the chordwise axis, perpendicular to the longitudinal axis. Similarly, half of the fibers of a +/−45° woven fabric are oriented at +45° from the longitudinal axis and the other half of the fibers are oriented at −45° from the longitudinal axis. The woven fabric can be a carbon woven fabric, such as a carbon woven fabric containing IM7 high modulus carbon fibers, to which resin is added to form a composite. In one example, the woven fabric is a 5 harness satin (5HS) material. Alternatively, the woven fabric can be a prepreg. In a prepreg material, the fibers, resin, and a suitable curing agent are combined. Further, the prepreg material can be a hybrid prepreg which contains two different types of fibers and an epoxy resin. Example prepreg hybrids include hybrids containing an epoxy and two different types of carbon fibers, such as low modulus carbon fibers (modulus of elasticity below about 200 giga-Pascals (GPa)), standard modulus carbon fibers (modulus of elasticity between about 200 GPa and about 250 GPa), intermediate modulus carbon fibers (modulus of elasticity between about 250 GPa and about 325 GPa) and high modulus carbon fibers (modulus of elasticity greater than about 325 GPa). In one example, the prepreg hybrid is a standard modulus carbon fiber/high modulus carbon fiber/epoxy hybrid. Example prepreg hybrids also include carbon fibers/boron fibers/epoxy hybrid prepregs.

In contrast to woven fabrics, a uniweave material has about 93-98% of its fibers oriented along longitudinal axis 48 of blade 32. A small number of fibers extend perpendicular to longitudinal axis 48 and stitch the uniweave material together.

The fiber orientation affects the strength of the material. For example, a composite formed of a 0/90° 5HS woven fabric has a modulus of approximately 75 giga-Pascals (GPa) (11 million pounds per square inch (msi)) in both the 0° and 90° directions, where 0° represents the longitudinal axis (span direction) of blade 32. In comparison, a composite formed of a 0° uniweave material comprising the same fibers has a modulus of approximately 165 GPa (24 msi) in the 0° direction and approximately 9.6 GPa (1.4 msi) in the 90° direction. Each ply 50 can be formed of the same material or the ply layup can be designed to locate woven fabrics and uniweave material where it is most beneficial.

Plies 50 also vary in shape and size as illustrated. The design or ply layup of plies 50 can be controlled to manage the locations of specific materials and to manage the locations of the edges of plies 50, particularly the leading and trailing edges 34 and 36 of plies 50. A ply drop is formed at the edge of each ply 50. Ply drops provide initiation sites for damage and cracks. The weakest region for laminated composites is the interlaminar region between the laminates. High interlaminar shear stresses, such as from operational loads and foreign object strikes, in a laminated composite can cause delamination that compromises the structural integrity of the structure. The ply drops in composite blade 32 are staggered and spread apart to prevent crack/delamination propagation. In one example, the ply drops in composite blade 32 are arranged to have a 20:1 minimum ratio of ply drop distance to ply thickness.

Plies 50 enable tailoring the structural properties of composite blade 32. Particularly, plies 50 enable tailoring the strength and stiffness of different regions of the blade. For example, additional torsional stiffness can be added to a region of blade 32 by using plies 50 having off-axis fibers while the bending stiffness of another region of blade 32 can be increased by using plies 50 having spanwise oriented fibers.

FIGS. 3a, 3b and 3c are cross-sectional views of composite blade 32 taken along line 3a-3a, line 3b-3b and line 3c-3c, respectively. As shown, composite blade 32 includes woven core or preform 52 and plies 50. Preform 52 is a three-dimensional woven core formed from a plurality of yarns as described further below. Preform 52 extends the spanwise length of composite blade 32 from root 46 to tip 44. Preform 52 also extends the chordwise width of composite blade 32 from leading edge 34 to trailing edge 36. The shape of preform 52 generally follows the shape of blade 32.

A first filament reinforced airfoil ply section on pressure side 38 of blade 32 comprises a plurality of plies 50, and a second filament reinforced airfoil ply section on suction side 40 comprises a plurality of plies 50. First and second filament reinforced airfoil ply sections are represented by a single ply 50 although each section comprises a plurality of plies 50 as illustrated in FIG. 2.

Preform 52 is a woven three-dimensional preform formed of a plurality of yarns. Preform 52 extends through composite blade 32 and is located between plies 50 on pressure side 38 and plies 50 on suction side 40. Preform 52 can extend in the span-wise direction from root 46 to tip 44 and can extend in the chord-wise direction from leading edge 34 to trailing edge 36. The number of yarns, types of yarns and weave pattern of preform 52 can be tailored as described further below to further tailor the properties of composite blade 32.

FIG. 3b illustrates the dovetail shape of root 46. Dovetail root 46 has a divergent shape such that root 46 is thicker than airfoil 42. Composite blade 32 (and thus preform 52) is connected to the fan mechanism of turbofan 12 by root 46. The additional thickness of root 46 enables composite blade 32 to withstand forces from standard operation and from foreign object impacts. Plies 50 can extend the length of root 46 as shown. Alternatively, plies 50 can end before root 46 so that root 46 is formed only by preform 52.

FIG. 3c is an enlarged cross-sectional view of composite blade 32 at tip 44. As shown, preform 52 can extend to the end of tip 44. Composite blade 32 can have a relatively constant thickness at tip 44. Alternatively, the thickness of blade 32 can decrease with increasing distance from root 46. The change in thickness can be accomplished by decreasing the thickness of plies 50, the thickness of preform 52 or both.

To form composite blade 32, preform 52 and plies 50 are stacked in a mold, injected with resin and cured. Example resins include but are not limited to epoxy resins and epoxy resins containing an additive, such as rubber. Alternatively, airfoil plies 50 can be pre-impregnated composites, (i.e. “prepregs”) such that resin is not directly added to the mold.

Plies 50 are stacked on either side of preform 52 according to a ply layup. Typically the ply layup on pressure side 38 is a minor image of the ply layup on suction side 40 of blade 32. Plies 50 tailor the surface of preform 52 to form the exterior surface profile of blade 32. Plies 50 also provide strength. Depending on the design, plies 50 may not be present at root 46. Root 46 of preform 52 can be tailored to a desired thickness without plies 50 adding the additional thickness.

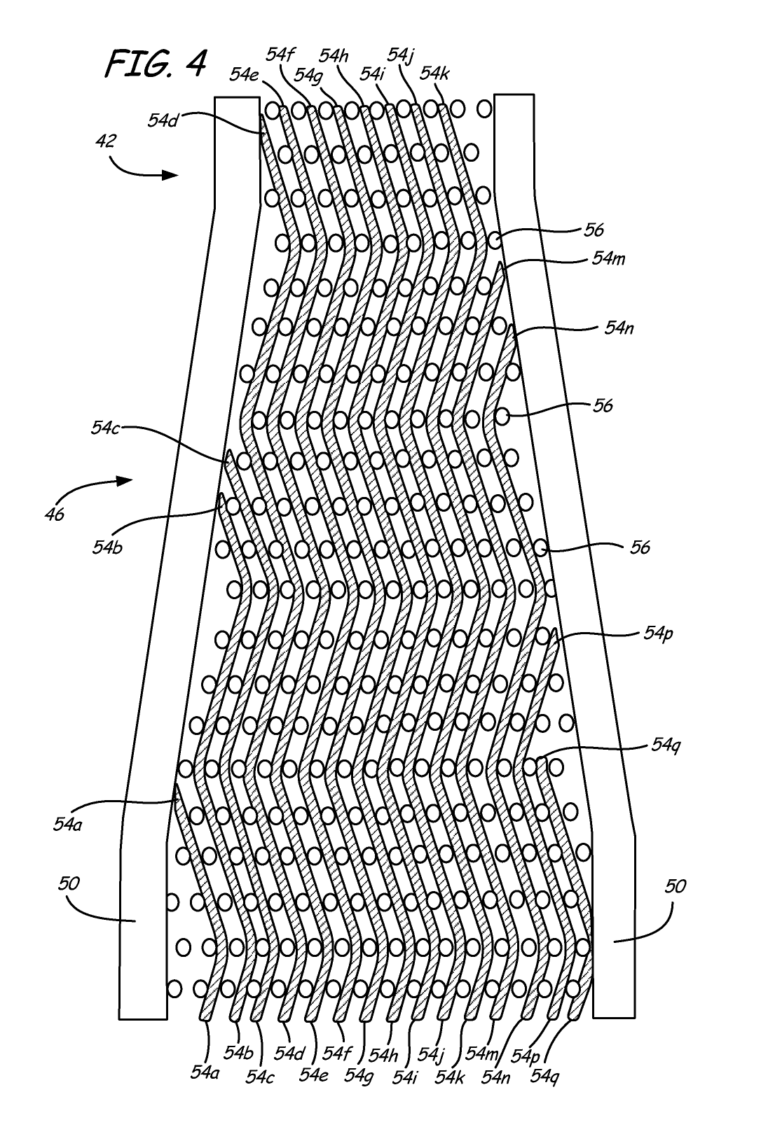

FIG. 4 is an enlarged cross-sectional view of root 46 which shows the details of preform 52. Preform 52 is a three-dimensionally integrally woven structure that includes warp yarns 54a through 54q (referred to generally as warp yarns 54) and weft yarns 56. Warp yarns 54 extend in a longitudinal (or spanwise) direction between root 46 and tip 44 of preform 52. Weft yarns 56 are placed at a 90 degree angle to the direction of warp yarns 54 and are aligned in a chordwise direction of preform 52. Weft yarns 56 extend between leading edge 34 and trailing edge 36 of preform 52.

Warp yarns 54 and weft yarns 56 of preform 52 are formed from bundles of fibers. Example fibers for yarns 54 and 56 include but are not limited graphite fibers, glass and glass-based fibers, polymeric fibers, ceramic fibers (such as silicon carbide fibers) and boron fibers and combinations thereof. Each individual yarn 54, 56 has a constant number of fibers extending the length of the yarn. The filament counts of yarns 54, 56 are referred to as the yarn sizes. It is noted that in an untensioned state, the yarn size is proportional to the diameter of the yarn. The larger the yarn size, the larger the diameter of yarn 54, 56. During the weaving process, yarns 54, 56 can become elliptical in cross-sectional shape or may have a non-circular cross-sectional shape. As used in this disclosure, yarn diameter refers to the diameter of the yarn prior to the weaving process. It is recognized that yarns 54, 56 may not have a circular cross-sectional shape following the weaving process.

Warp yarns 54 and weft yarns 56 are woven together to form integrally woven three-dimensional preform 52 with a layer-to-layer angle interlock weave pattern. Alternatively, preform 52 can have a through-thickness angle interlock weave pattern or an orthogonal weave pattern. Weft yarns 56 are arranged in columns that extend in the thickness direction (i.e. between pressure side 38 and suction side 40). The columns of weft yarns 56 have a staggered arrangement such that weft yarns 56 are off-set from adjacent weft yarns 56 in the spanwise direction. Alternatively, weft yarns 56 can be aligned with adjacent weft yarns 56 in the spanwise direction and stuffer yarns can extend in the spanwise direction between weft yarns 56.

FIG. 4 illustrates one of several planes that are repeated along the chordwise axis of preform 52 between leading and trailing edges 34 and 36. The other planes are similar to the plane shown expect that warp yarns 54 are shifted in the spanwise direction such that warp yarns 54 and weft yarns 56 are interlocked at different locations on each plane.

As described above, root 46 has a divergent shape. Root 46 is thickest at its base, which is the portion of root 46 furthest from airfoil 42, and the thickness of root 46 gradually decreases with decreasing distance to airfoil 42. The thickness of blade 32 is significantly different between the base of root 46 and airfoil 42. In one example, root 46 is between about 3.8 cm to about 6.35 cm (about 1.5 inch to about 2.5 inches) thick at the base and is about 2.5 cm (about 1.0 inches) thick where airfoil 42 meets root 46. Plies 50 can be generally the same thickness along blade 32 and preform 52 can be woven to create the desired change in thickness.

In order to form the divergent shape of root 46, select warp yarns 54 can be removed during the weaving process to reduce the thickness of preform 52. There are three different types of warp yarns 54: surface warp yarns, below surface mid-plane warp yarns and below surface non-mid-plane warp yarns. Surface warp yarns are warp yarns 54 that are on or form the surface of preform 52. Warp yarns 54a, 54b, 54c, 54d, 54k, 54m, 54n, 54p and 54q are surface warp yarns in at least a region of preform 52. Below surface warp yarns are warp yarns 54 that are below the surface of preform 52. Warp yarns 54e, 54f, 54g, 54h, 54i and 54j are examples of below the surface warp yarns. The classification of a warp yarn 54 can vary along the length of preform 52. For example, warp yarn 52d is a below surface warp yarn at the base of root 46 and is a surface warp yarn where root 46 adjoins airfoil 42.

Below surface warp yarns are divided into two groups based on their location relative to the mid-plane of preform 52. Warp yarns at the mid-plane of preform 52 and warp yarns immediately surrounding such warp yarns are below surface mid-plane warp yarns. Warp yarns 54g, 54h and 54i are examples of below surface mid-plane warp yarns. Below surface warp yarns that are not adjacent to the mid-plane of preform 52 are below surface non-mid-plane warp yarns. Warp yarns 54e, 54f and 54j are examples of below surface non-mid-plane warp yarns.

In FIG. 4, surface warp yarns 54 are selectively removed to decrease the thickness of preform 52. The warp yarns 54 that are selectively removed do not extend the entire length of preform 52. For example, warp yarns 54a, 54b, 54c, 54m, 54n, 54p and 54q are selectively removed at various locations along preform 52. Warp yarns 54 are selectively removed from preform 52 after they have been woven for a length of preform 52.

Warp yarns 54 are selectively removed at various locations along the spanwise length of preform 52. By removing warp yarns 54 at various locations, the gentle tapered shape of root 46 is formed. For example, warp yarn 54a is included in the weave pattern at the base of root 46 and is selectively removed from the weave pattern when the thickness of root 46 must be reduced to form the tapered shape. Thus, warp yarn 54a provides thickness at the base of root 46 but does not add additional thickness in regions of root 46 that are closer to airfoil 42.

Warp yarns 54 and weft yarns 56 can be woven using an automated loom. During the weaving process, each warp yarn 54 is drawn through an opening in a wire called a heddle whose motion can be controlled either by a harness or by a programmable loom head. Each heddle can be individually controlled to raise or lower each individual warp yarn. Individual weft yarns 56 are inserted through the opening (or shed) between raised and lowered warp yarns 54 from a side of the loom. More specifically, warp yarns 54 are parted to form a first shed in the chordwise direction. A single weft yarn 56 is inserted through this shed. Warp yarns 54 are then parted in the opposite direction to form a second shed and to interlock weft yarn 56 that was passed through the first shed. A second weft yarn 56 is passed through the new shed formed and the process is repeated to weave preform 52 in the spanwise direction. To selectively remove a warp yarn 54, such as warp yarn 54a, warp yarn 54a is no longer moved to form the sheds through which weft yarns 56 pass. After a specified length of weaving, a selected warp yarn 54 is selectively removed and it is no longer included in the weave pattern.

It should be noted that selectively removing warp yarns 54 results in also removing select weft yarns 56. As described above, warp yarns 54 interweave weft yarns 56. Thus, when warp yarns 54 are removed, select weft yarns 56 are no longer woven together. In one example, root 46 contains sixteen weft yarns 56 at the base and nine weft yarns 56 where root 46 meets airfoil 42.

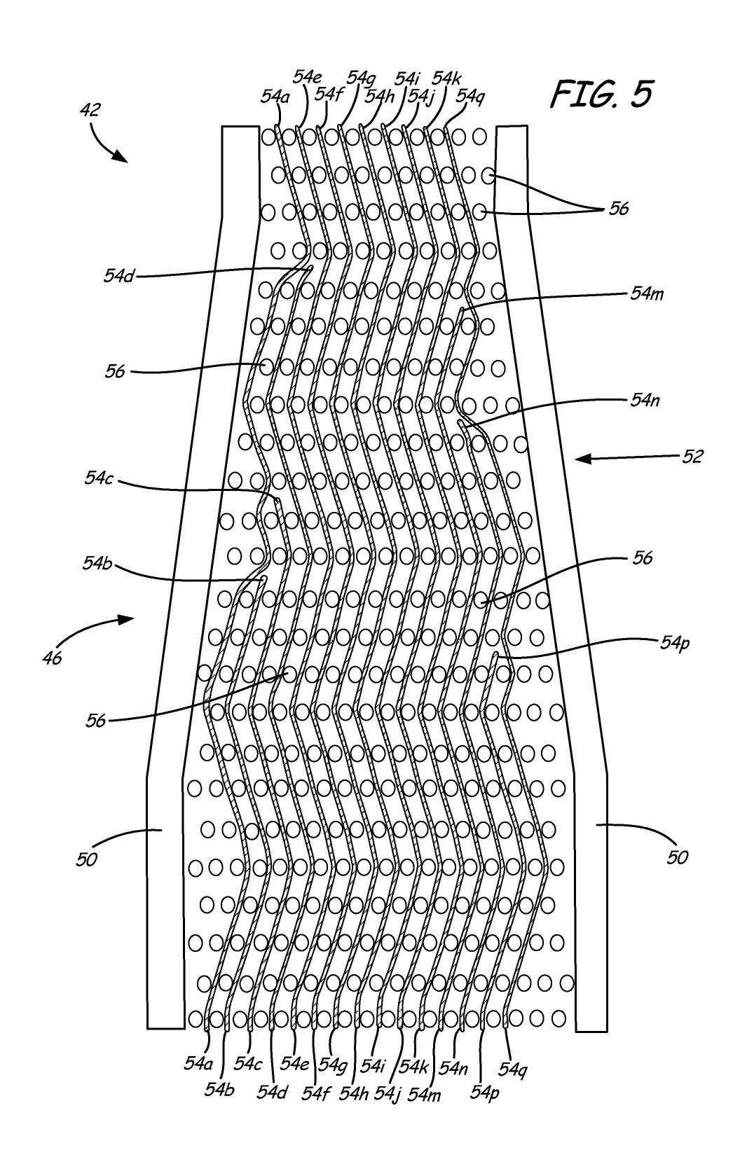

In FIG. 4, surface warp yarns 54, such as warp yarn 54a, are selectively removed or dropped. Alternatively, as shown in FIG. 5, below surface non-mid-plane warp yarns 54, such as warp yarn 54d, can be selectively removed to reduce the thickness of preform 52. In FIG. 5, surface warp yarns 54a and 54q extend the entire length of preform 52 from root 46 through airfoil 42. Below surface mid-plane warp yarns 54g, 54h and 54i also extend the length of preform 52. Below surface non-mid-plane warp yarns 54b, 54c, 54d, 54m, 54n and 54p are selectively removed or dropped during the weaving process. Selectively removing below surface non-mid-plane warp yarns 54b, 54c, 54d, 54m, 54n and 54p creates the gentle tapered shape of root 46. Below surface mid-plane warp yarns, such as warp yarn 54i, can also be selectively removed. Selectively removing or dropping below surface warp yarns 54 is accomplished by a method similar to that described above with respect to surface warp yarns 54. To selectively remove or drop below surface warp yarn 54d, warp yarn 54d is not incorporated into the weave pattern after it has been woven for a specified distance along the spanwise length of preform 52. Selectively removing below surface warp yarns 54 maintains the integrity of the surfaces, such as the pressure and suction side surfaces of preform 52. Because below surface warp yarns 54 are towards the center of preform 52, surface warp yarns 54a and 54q continue to extend from root 46 to tip 44 even after one below surface weft yarn 54, such as weft yarn 54f, is selectively removed. Continuous surface warp yarns 54a and 54q maintain the integrity of the surface of preform 52. Removing below surface warp yarns 54 prevents unwoven warp yarns on the surface of preform 52. Instead, unwoven warp yarns 54 are present in the body of preform 52 where surrounding yarns assist in maintaining the integrity of the weave.

Mid-plane warp yarns 54, such as warp yarn 54h, can also be selectively removed from preform 52 after weaving for a distance. However, in one example, mid-plane warp yarn 54h is not removed in order to maintain the integrity of the mid-plane of preform 52. Preform 52 experiences high interlaminar shear stresses along the mid-plane. Maintaining mid-plane warp yarn 54h from root 46 to tip 44 of preform 52 increases the strength of preform 52 along the mid-plane.

Selectively removing warp yarns 54 enables a single weave pattern to be used throughout preform 52. That is, the same weave pattern extends from root 46 to tip 44 of preform 52. Using a single weave pattern simplifies manufacturing. Because preform 52 is integrally woven in three dimensions, transitioning between different weave patterns in different regions of preform 52 is complicated and complex. For example, when transitioning between weave patterns includes managing yarns and weave patterns that extend in all three directions. Such complexities are eliminated and the manufacturing process is simplified by using a single weave pattern throughout preform 52.

Using plies 50 with preform 52 enables materials to be used where they are most beneficial. Plies 50 and preform 52 each enable tailoring of the properties of blade 32. Plies 50 provide a large amount of in-plane stiffness and strength and the interlocking fibers of preform 52 provide high interlaminar strength.

The sandwich configuration of composite blade 32 having plies 50 and preform 52 provides additional variables for tailoring and tuning composite blade 32. Plies 50 can be located at regions on blade 32 that require high in-plane strength and stiffness, and plies 50 can be removed from regions of blade 32 that do not require such strength and stiffness. The number of plies 50 and the fiber orientation of plies 50 can be designed to achieve desired properties as described above.

Blade 32 experiences the greatest shear stresses towards the center or the mid-plane of blade 32. By sandwiching preform 52 between plies 50, preform 52 is located generally in the center of blade 32. The interlocking fibers (i.e. warp yarns 54 and weft yarns 56) increases the interlaminar strength of blade 32. The interlaminar strength provided by preform 52 is particularly beneficial to counteract forces and stresses from foreign object impacts.

The use of plies 50 together with preform 52 also improves the flexibility of the blade design of composite blade 32. In the sandwich construction of composite blade 32, the use of plies 50 enables the design of plies 50 to be changed to further tailor the properties of blade 32 without changing the weave pattern of preform 52. This eliminates redesigning preform 52 for small changes in the shape or thickness of composite blade 32.

Plies 50 and preform 52 each contribute to improving the properties of blade 32. The interwoven fibers of preform 52 provide high interlaminar strength to counteract forces and stresses produced during blade impacts, and the fibers of plies 50 improve other mechanical properties of blade 32, such as bending stiffness and in-plane stiffness, and improve the ability to tailor the torsional stiffness and the vibrational properties of blade 32.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. For example, although selectively removing warp yarns 54 to reduce the thickness of root 46 is discussed above, yarns 54 can be selectively removed in any region of preform 52 in order to change the thickness of preform 52. Therefore, it is intended that the invention not be limited to the particular embodiment(s) disclosed, but that the invention will include all embodiments falling within the scope of the appended claims.

1. A composite blade having a root, a tip, a pressure side and a suction side, the composite blade comprising:
a first filament reinforced airfoil ply section on the pressure side of the composite blade;
a second filament reinforced airfoil ply section on the suction side of the composite blade; and
a three-dimensionally woven core extending from the root to the tip of the composite blade and located between the first and second filament reinforced airfoil ply sections, the woven core comprising:
first yarns extending in a chordwise direction; and
second yarns extending a spanwise direction, wherein there is a greater number of second yarns in a first region of the woven core than in a second region of the woven core.

2. The composite blade of claim 1, wherein the second yarns include surface second yarns located at the surface of the three-dimensionally woven core and below surface second yarns located below the surface of the three-dimensionally woven core, and wherein there is a greater number of below surface second yarns in the first region than in the second region of the woven core.

3. The composite blade of claim 2, wherein the below surface second yarns include mid-plane second yarns adjacent a mid-plane of the woven core and non-mid-plane second yarns, and wherein there is a greater number of non-mid-plane second yarns in the first region than in the second region of the woven core.

4. The composite blade of claim 1, wherein the first region and the second region are adjacent to one another in the spanwise direction.

5. The composite blade of claim 1, wherein the first region is a root and the second region is a tip.

6. The composite blade of claim 1, wherein the first filament reinforced airfoil ply section comprises a plurality of two-dimensional fiber reinforced plies.

7. The composite blade of claim 6, wherein the two-dimensional fiber reinforced plies include at least one of a uniweave material and a woven fabric.

8. A method of forming a composite blade, the method comprising:
weaving first and second yarns to form a three-dimensionally woven core;
removing select second yarns after weaving a length of the select yarns to reduce a thickness of the three-dimensionally woven core; and
positioning the three-dimensionally woven core between a first fiber reinforced laminate section and a second fiber reinforced laminate section.

9. The method of claim 8, wherein the first yarns extend in a chordwise direction and the second yarns extend in a spanwise direction.

10. The method of claim 8, wherein the second yarns are removed from a tip of the composite blade so that the tip of the composite blade contains less second yarns than a root of the composite blade.

11. The method of claim 8, wherein the step of weaving the first and second yarns comprises:
forming a shed in the second yarns;
passing one first yarn through the shed formed in the second yarns; and
moving the second yarns after the first yarn is passed through the shed to interweave the first and second yarns.

12. The method of claim 9, wherein the step of removing select second yarns comprises:
removing select below surface second yarns located below a surface of the woven core.

13. The method of claim 9, wherein the step of removing select second yarns comprises:
removing select below surface non-mid-plane second yarns.

14. The method of claim 9, wherein the first filament reinforced laminate section and a second fiber reinforced laminate section include uniweave and woven fiber reinforced plies.

15. A composite blade having a root, a tip, a pressure side and a suction side, the composite blade comprising:
first and second filament reinforced laminate sections; and
a three-dimensionally woven core extending from the root to the tip of the composite fan blade between the first and second filament reinforced laminate sections, the woven core comprising:
weft yarns; and
warp yarns extending in a spanwise direction from root to tip and interweaving the weft yarns, wherein select warp yarns extend between the root and a location intermediate the root and tip.

16. The composite blade of claim 15, wherein the warp yarns include surface warp yarns and below surface warp yarns and select below surface warp yarns extend between the root and the location intermediate the root and the tip.

17. The composite blade of claim 16, wherein the below surface warp yarns include mid-plane warp yarns and non-mid-plane warp yarns and select non-mid-plane warp yarns extend between the root and the location intermediate the root and the tip.

18. The composite blade of claim 15, wherein the first and second filament reinforced laminate sections include uniweave plies and woven plies.
